(19) United States
(12) Patent Application Publication
(10) Pub. No.: US 2006/0259369 A1
(43) Pub. Date: Nov. 16, 2006

(54) Virtual grocery shopping

(75) Inventors: Stacy Leigh Bongrazio, Raleigh, NC (US); Hye Suk Chi, Raleigh, NC (US); Paul Daniel Kangas, Cary, NC (US); Robert Andrew Myers, Cary, NC (US); Jeff David Thomas, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/127,678

(22) Filed: May 12, 2005

(51) Int. Cl. G06Q 30/00

(52) U.S. Cl. 705/26; 705/27

(57) ABSTRACT

A method and system that allows an on-line shopper to be assigned a queue number for each department in a store is presented. Each time the shopper's number comes up in a queue in a specific store department, a real-time audio/video session is initiated between the shopper and a personal assistant who is physically located in that specific department. Thus, the shopper is able to seamlessly and instantly move from department to department with minimal waiting down-time.

### BACKGROUND OF THE INVENTION

1. Technical Field

The present invention relates in general to the field of computers, and in particular to on-line shopping. Still more particularly, the present invention relates to a method and system for allowing an on-line shopper to be assigned a “place in line” for real-time on-line assistance from a person in a department of a store.

2. Description of the Related Art

For most people, weekly grocery shopping is an unpleasant chore, due to the hassle of dealing with inclement weather, finding a parking spot, jostling with crowds and basket carts, etc. Oftentimes, these “hassles” are more than mere inconveniences, but are real limitations for people with physical or mental handicaps.

To address this problem, on-line shopping services are offered. However, such services are typically limited in the features they offer, which typically involve selecting items from a database, adding them to a virtual shopping “cart,” and then sending a paid order to a warehouse for pulling and delivery of the selected items. Such systems do not provide the type of on-site personal assistance that would be needed for the shopper to visually inspect a particular item. For example, a grocery shopper may want to look at a specific cut of meat or a piece of fish before committing to a purchase of that item.

With regards to packaged products, the customer may require product information that is printed on a package, but not found in a centralized database, such as nutrition information, recipes, coupons and other advertising promotions, etc. Thus, a personal assistant is needed at the store to read or show this information to the customer.

The prior art offers no seamless way for a shopper to obtain such personal assistance when other shoppers are also waiting for personal assistance, particularly where the store has both on-line as well as on-site customers waiting in line for assistance, and more particularly where the store has multiple departments in which personal assistance is needed by the shopper.

### SUMMARY OF THE INVENTION

In light of the limitations of the prior art, the present invention provides for a method and system that allows an on-line shopper to be assigned a queue number for each department in a store. Each time the shopper's number comes up in a queue in a specific store department, a real-time audio/video session is initiated between the shopper and a personal assistant who is physically located in that specific department. Thus, the shopper is able to seamlessly and instantly move from department to department with minimal waiting down-time.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1a depicts an exemplary computer system used by a shopper in the present invention;

FIG. 1b illustrates an exemplary computer system used in a store department in accordance with the present invention;

FIG. 2a depicts a network-based computer connection between the computer systems shown in FIGS. 1a-b;

FIG. 2b illustrates software used by the store computer illustrated in FIG. 1b in accordance with the present invention;

FIG. 3 depicts an exemplary Graphical User Interface (GUI) allowing the shopper to choose a particular department in which assistance is needed;

FIGS. 4a-b illustrate an exemplary GUI showing a real-time video feed from the store department to the shopper; and

FIG. 5 is a high-level flow chart of steps taken in a preferred embodiment of the present invention.

### DETAILED DESCRIPTION OF THE PREFERRED EMBODIMENT

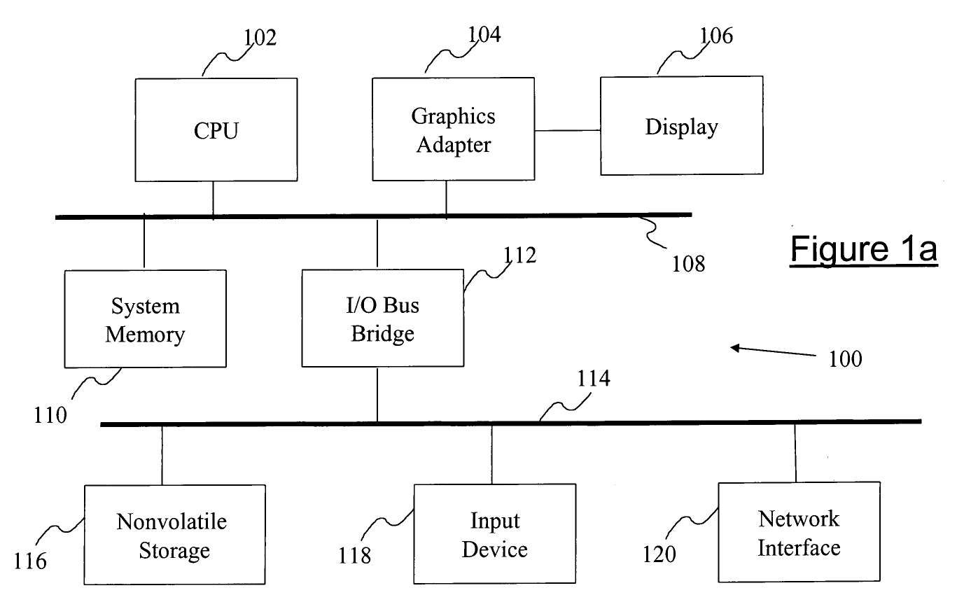

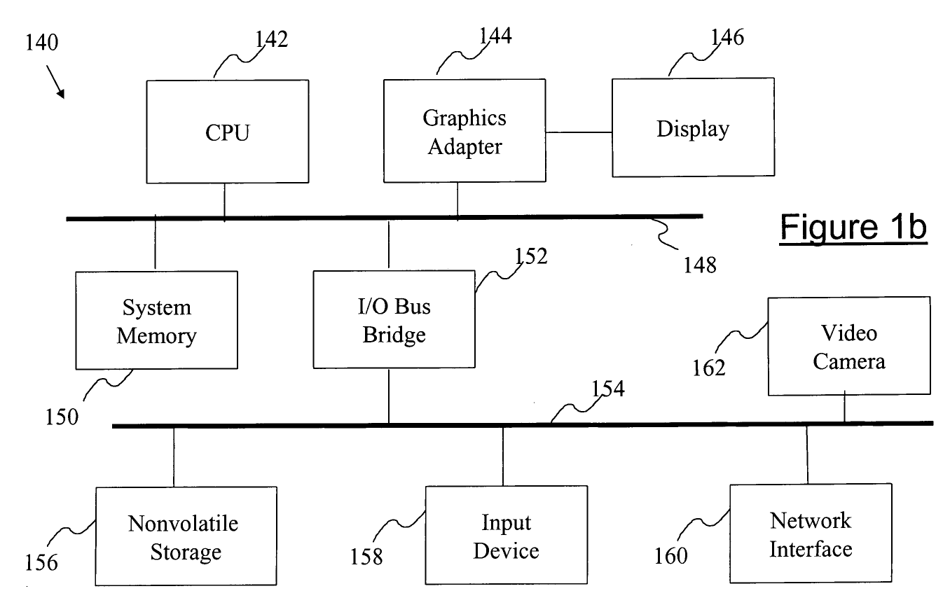

With reference now to the figures, and particularly to FIG. 1a, there is depicted a block diagram of an exemplary data processing system which may be used by a shopper in accordance with the present invention. Data processing system 100 may be, for example, one of the models of personal or server computers available from International Business Machines Corporation of Armonk, N.Y. Data processing system 100 includes a central processing unit (CPU) 102, which is connected to a system bus 108. In the exemplary embodiment, data processing system 100 includes a graphics adapter 104 also connected to system bus 108, for providing user interface information to a display 106.

Also connected to system bus 108 are a system memory 110 and an input/output (I/O) bus bridge 112. I/O bus bridge 112 couples an I/O bus 114 to system bus 108, relaying and/or transforming data transactions from one bus to the other.

Connected to I/O bus 114 is a nonvolatile storage 116, which may be a hard disk drive, an optical drive such as used by a Compact Disk Read Only Memory (CD-ROM), a magnetic cassette drive, flash memory cards, a digital versatile disks (DVD), a Bernoulli cartridge or any other similar type of storage device for data storage known to those skilled in the art.

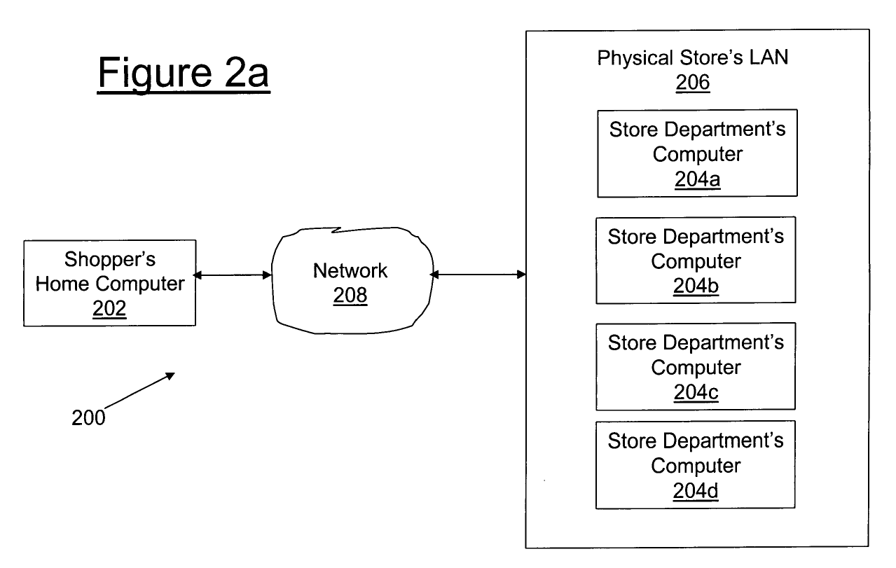

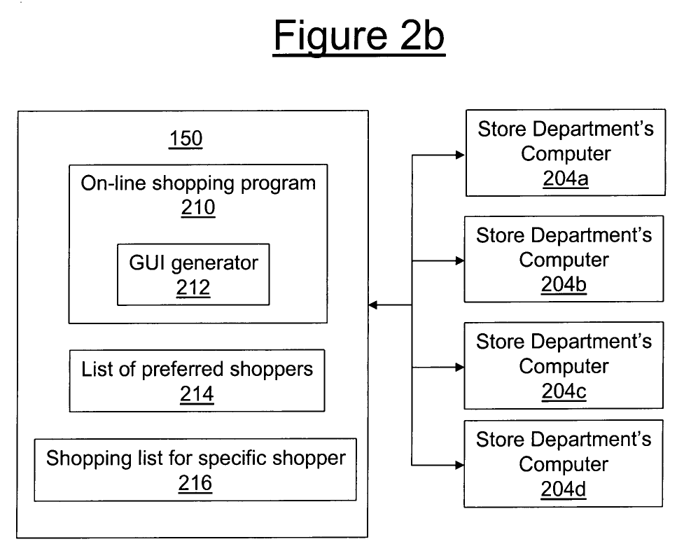

Also coupled to I/O bus 114 are one or more input devices 118, which may be, for example, one or more of a keyboard, a mouse, a microphone, a web camera (or other video camera), etc. Also coupled to I/O bus 114 is a network interface 120, preferably a Network Interface Card (NIC), capable of being coupled to a network such as network 208 shown in FIG. 2a below.

With reference now to FIG. 1b, there is depicted a block diagram of an exemplary data processing system which may be used by a physical store department in accordance with the present invention. Data processing system 140 may be, for example, one of the models of personal or server computers available from International Business Machines Corporation of Armonk, N.Y. Data processing system 140 includes a central processing unit (CPU) 142, which is connected to a system bus 148. In the exemplary embodiment, data processing system 140 includes a graphics adapter 144 also connected to system bus 148, for providing user interface information to a display 146.

Also connected to system bus 148 are a system memory 150 and an input/output (I/O) bus bridge 152. 1/0 bus bridge 152 couples an I/O bus 154 to system bus 148, relaying and/or transforming data transactions from one bus to the other.

Connected to I/O bus 154 is a nonvolatile storage 156, which may be a hard disk drive, an optical drive such as used by a Compact Disk Read Only Memory (CD-ROM), a magnetic cassette drive, flash memory cards, a digital versatile disks (DVD), a Bernoulli cartridge or any other similar type of storage device for data storage known to those skilled in the art.

Also coupled to I/O bus 154 are one or more input devices 158, which may be, for example, one or more of a keyboard, a mouse, a microphone, etc. Also coupled to I/O bus 154 is a network interface 160, preferably a Network Interface Card (NIC), capable of being coupled to a network such as network 208 shown in FIG. 2a below. Also coupled to I/O bus 154 is a video camera 162, which may be a web camera capable of producing streaming real-time video packets, including those conforming to the Moving Picture Experts Group (MPEG) format.

The exemplary embodiments shown in FIGS. 1a-b are provided solely for the purposes of explaining the invention and those skilled in the art will recognize that numerous variations are possible, both in form and function.

With reference now to FIG. 2a, there is depicted an exemplary network-based computer connection 200, in which a shopper's home computer 202 is coupled via a network 208 to a plurality of store department's computers 204 that are connected to a physical store's Local Area Network (LAN) 206. Note that shopper's home computer 202 is depicted in exemplary detail in FIG. 1a, store department's computers 204 are described in exemplary detail in FIG. 1b, and network 208 is preferably the Internet.

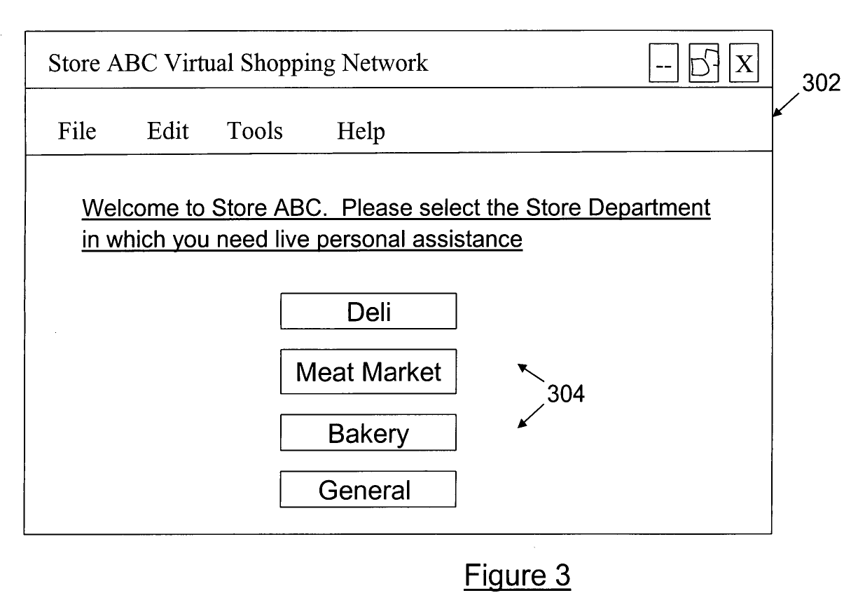

As shown in FIG. 2b, system memory 150 of the store department's computers 204 contain, or have access to, an on-line shopping program 210, which includes a Graphical User Interface (GUI) generator 212, for producing GUI's such as shown below in FIG. 3 et seq. On-line shopping program 210 contains computer program code that permits, inter alia, an on-line shopper to log into the store's LAN, and establish real-time audio/video streaming communication with different departments in the physical store. Also contained within system memory 150 is a list of preferred shoppers 214, containing the identities of shoppers who are provided special treatment (e.g., being bumped up in line or being offered a special deal on one or more products) due to the shopper's loyal shopping history, store club membership, past high-volume of purchases, etc. System memory 150 also contains a shopping list for a specific shopper 216. This shopping list is created by the shopper on-line, such as by clicking items from a list or other similar means to send the store a list of what items the shopper wants to buy (and/or desires assistance with).

Referring now to FIG. 3, an exemplary Graphical User Interface (GUI) 302 as found on a shopper's computer is depicted. After signing into (logging into) a virtual shopping network supported by a physical store's LAN (and thus activating on-line shopping program 210), the shopper may receive data that generates GUI 302, welcoming her to the shopping network and asking her to select one of buttons 304 to choose which department in the physical store location she needs real-time live personal assistance. The shopper may select assistance from any specialized area (e.g., “Deli,” “Meat Market,” “Bakery”), and/or “General” for assistance from a personal shopper who will float throughout the entire physical store. If the shopper chooses a department such as “Deli,” then the shopper will have an audio/video feed supplied from that department via a microphone and camera in that area. If the shopper selects the “General” option, then the shopper will be able to “follow” a personal assistant in the store via a camera change for each aisle. This camera change may be performed manually by the shopper (to allow her to peruse aisles without her personal assistant), or may follow (manually or automatically) the personal assistant. To automatically follow the personal assistant, each camera on each aisle may be slaved to a signal from the personal assistant that is generated by a transmitter, signal card, or any similar device, worn by the personal assistant, that controls which audio/video feed is provided to the on-line shopper.

Note that clicking the buttons 304 assigns a value of a queue number (“place in line”) for the shopper. That is, when the shopper first chooses to be placed in line for real-time assistance in a specific store department, the shopper is placed at the “back of the line” with a queue number reflecting her place in line. Alternatively, if the shopper is a “preferred shopper,” such as through membership in a shopping club through the store, or based on a shopping history (e.g., spending over a predetermined amount in the past), then the “preferred shopper” can be placed higher in the queue, causing her to be served before other “non-preferred” shoppers. Note that the shoppers in the queue preferably include both on-line shoppers (such as another shopper using another shopper's home computer 202 such as shown in FIG. 2) as well as on-site shoppers who are physically located in and shopping within the physical store location.

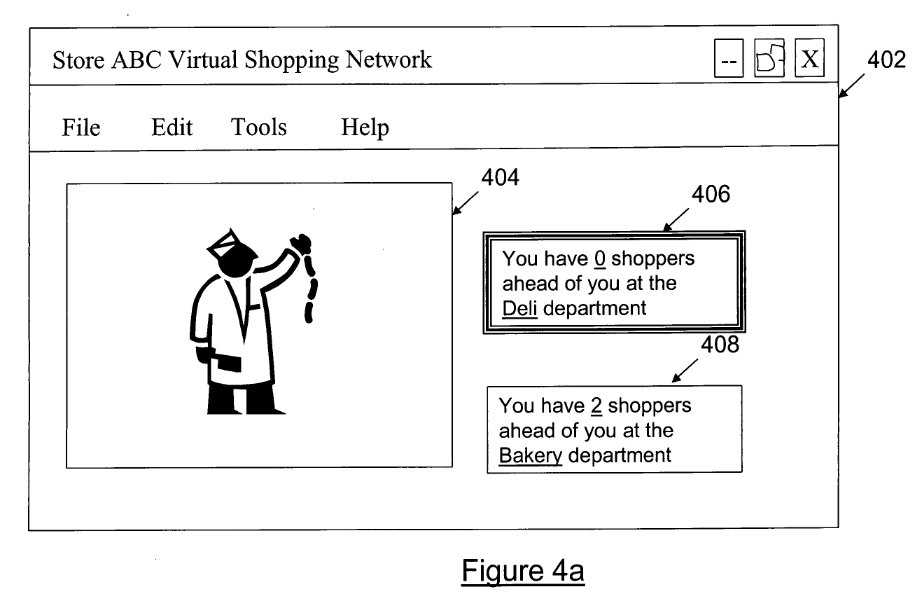

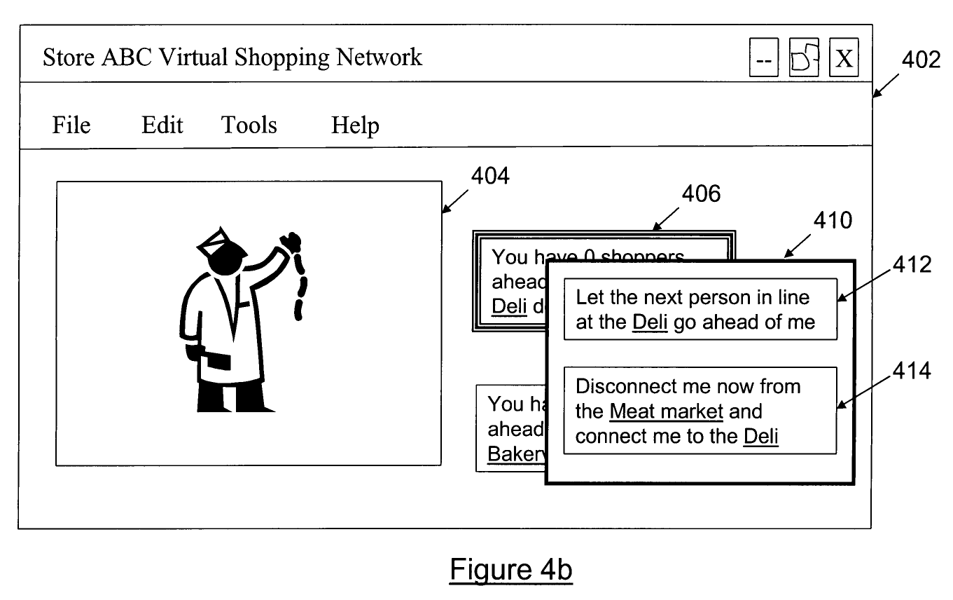

With reference to a GUI 402 shown in FIG. 4a, assume that the shopper selected “Deli,” “Meat Market,” and “Bakery” from GUI 302 shown in FIG. 3. Also assume that the “Meat Market” is currently available, as suggested by real-time video stream 404, in which the shopper has established both audio and video communication with a live person (butcher) in that department. While the butcher is providing real-time assistance to the shopper (e.g., showing requested cuts of meat), an active window 406 may indicate that the shopper has “0” customers in front of her at the “Deli” store department (preferably by changing a border on active window 406 to alert the shopper that she is next in line at this other department), and has two other shoppers ahead of her at the “Bakery” store department (active window 408). By clicking active window 406, a new active window 410, shown in FIG. 4b, will appear, giving the shopper the option of giving up her place in line (active window 412) in order to allow her to conclude her business with the butcher, or she may disconnect from the butcher to immediately connect with the “Deli” (active window 414).

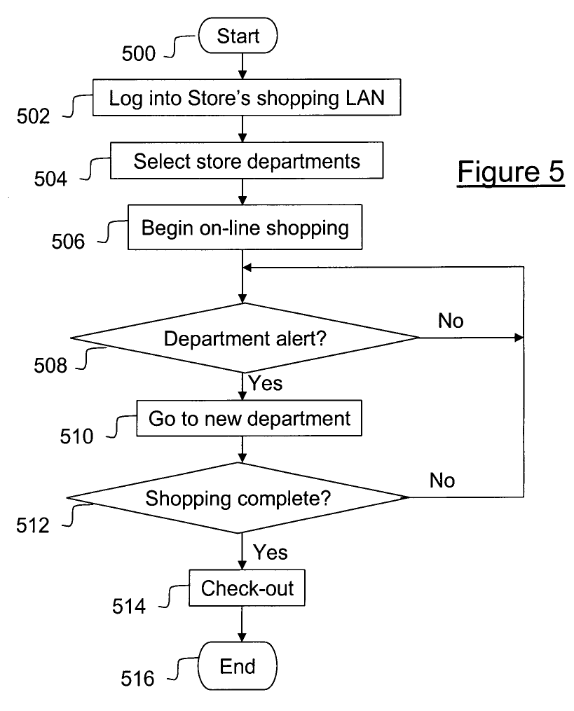

Referring now to FIG. 5, a flow-chart showing exemplary steps taken by the present invention is presented. After initiator block 500, a shopper logs into a store's shopping LAN (block 502). This results in the on-line shopping program automatically being called up, which identifies the shopper by his password, network address, store prompted information, or other identifier, and initiates the GUI described above in FIG. 3. The shopper selects which department(s) he wants help in (block 504), and begins on-line shopping (block 506). This shopping may be through a virtual shopping system, or preferably is through the use of a personal shopper who has previously received the shopper's shopping list, and is now communicating (using any combination of voice, data and video) with the shopper in real-time as the personal shopper navigates through the physical aisles in the store. Note that before being offered personal assistance in a department, the shopper may be required to (actively or tacitly) give his agreement that he will purchase over a specific amount of money in that department (or alternatively, will spend over a pre-determined amount of money in the entire store).

While shopping, the shopper may receive a department alert (query block 508), such as shown as active window 406 in FIG. 4a. If the shopper so chooses, he will click onto the department that sent the alert (block 510), allowing the shopper to initiate a real-time session with an assistant in that department.

As soon as all of the shopper's shopping is complete (query block 512), he proceeds to a check-out station (block 514), where he can pay on-line for the products selected, thus ending the process (terminator block 516). Alternatively, the shopper can wait until he comes to the physical store location (assuming that a delivery option was not offered or chosen) to pay for the selected products.

In an effort to replicate the social aspect of shopping, the present invention can also include the feature of allowing any shopper logged into the store's LAN to Instant Message (IM) or otherwise e-mail other shoppers that are logged into the store's LAN. Thus, if a shopper sees an item that he wishes to recommend to a friend, this can be done immediately via IM or e-mail to the friend.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
establishing a network-based computer connection between a shopper and a plurality of departments in a physical store location;
assigning a queue number to the shopper for each store department selected by the shopper for service assistance; and
in response to a specific store department reaching a queue number assigned to the shopper, establishing a communication link between the specific store department and the shopper via the network-based computer connection.

2. The method of claim 1, wherein the network-based computer connection is established between a home computer used by the shopper and a store computer used by each of the plurality of departments in the physical store location.

3. The method of claim 2, wherein the store computer has a video feed capability, wherein the shopper can view a live attendant in each selected specific store department.

4. The method of claim 2, further comprising:
an alert signal, sent to the home computer and recognizable by the shopper, indicating a queue position for each specific store department selected by the shopper.

5. The method of claim 1, wherein the network-based computer connection utilizes an Internet.

6. The method of claim 1, further comprising:
establishing an Instant Message (IM) connection between the shopper and other remote shoppers that are logged into the network-based computer connection.

7. The method of claim 1, wherein the shopper is a preferred customer, and wherein the shopper is assigned a queue number authorizing the shopper to be served before a non-preferred customer who has also selected a same store department for service assistance.

8. The method of claim 1, wherein the shopper must agree to purchase goods having a pre-determined minimum value before being allowed to establish a communication link with the specific store department.

9. The method of claim 1, further comprising:
an on-line check-out station, wherein the shopper can pay for products chosen from the physical store location.

10. The method of claim 1, wherein the shopper is in a same queue for service as on-site shoppers.

11. A computer program product, residing on a computer usable medium, comprising:
program code for establishing a network-based computer connection between a shopper and a plurality of departments in a physical store location;
program code for assigning a queue number to the shopper for each store department selected by the shopper for service assistance; and
program code for in response to a specific store department reaching a queue number assigned to the shopper, establishing a communication link between the specific store department and the shopper via the network-based computer connection;

12. The computer program product of claim 11, wherein the network-based computer connection is established between a home computer used by the shopper and a store computer used by each of the plurality of departments in the physical store location.

13. The computer program product of claim 12, wherein the store computer has a video feed capability, wherein the shopper can view a live attendant in each selected specific store department.

14. The computer program product of claim 12, further comprising:
program code for an alert signal, sent to the home computer and recognizable by the shopper, indicating a queue position for each specific store department selected by the shopper.

15. The computer program product of claim 11, wherein the network-based computer connection utilizes an Internet.

16. The computer program product of claim 11, further comprising:
program code for establishing an Instant Message (IM) connection between the shopper and other remote shoppers that are logged into the network-based computer connection.

17. The computer program product of claim 11, wherein the shopper is a preferred customer, and wherein the shopper is assigned a queue number authorizing the shopper to be served before a non-preferred customer who has also selected a same store department for service assistance.

18. The computer program product of claim 11, wherein the shopper must agree to purchase goods having a pre-determined minimum value before being allowed to establish a communication link with the specific store department.

19. The computer program product of claim 11, further comprising:
program code for an on-line check-out station, wherein the shopper can pay for products chosen from the physical store location.

20. The computer program product of claim 11, wherein the shopper is in a same queue for service as on-site shoppers.
